(19) United States
(12) Patent Application Publication
(10) Pub. No.: US 2002/0140758 A1
(43) Pub. Date: Oct. 3, 2002

(54) Compensation for device aging

(75) Inventors: Thomas E. Watrobski, Penfield, NY (US); Juan J. Becerra, Webster, NY (US)

Correspondence Address: OLIFF & BERRIDGE, PLC, P. O. BOX 19928, ALEXANDRIA, VA, 22320, US

(73) Assignee: XEROX CORPORATION

(21) Appl. No.: 09/820,705

(22) Filed: Mar. 30, 2001

(51) Int. Cl. B41J 29/393; B41J 29/38

(52) U.S. Cl. 347/19; 347/7; 347/14

(57) ABSTRACT

Print quality is maintained by determining print conditions based on varying threshold values over the printhead lifetime before the print run. In particular, print conditions are determined through periodic quality adjustment cycles based on detected long-term and short-term temporal drift of print thresholds. A detector is provided to detect the presence or absence of ink being ejected from an inkjet printer. A sequence of eject and detect cycles over varying control conditions is performed to determine the minimum condition required to eject ink from the printer.

### BACKGROUND OF THE INVENTION

1. Field of Invention

This invention relates to systems and methods for compensating for device aging over thermal ink jet printhead and printbar lifetime.

2. Description of Related Art

Liquid ink printers, which includes both continuous stream type printers and drop-on-demand type printers, such as piezoelectric, acoustic, phase change wax-based or thermal printers, have at least one cartridge from which droplets of ink are ejected or otherwise directed towards a recording medium. Within the cartridge, the ink is contained in a plurality of channels. Power pulses cause the droplets of ink to be ejected as required from print elements provided at the end of the channels. The ink within the channel retracts and separates from the bulging ink to form a droplet moving in a direction away from a print element and towards the recording medium where the drop is deposited to form a dot or spot of ink. The channel then refills by drawing ink from a supply container of the liquid ink. The resulting dots or spots become part of a desired image.

### SUMMARY OF THE INVENTION

In various exemplary embodiments of the methods and systems of the present invention, print conditions for controlling ink ejection are compared with predetermined threshold values. The ejection of the ink is controlled in accordance with the threshold comparison result.

In various exemplary embodiments of the methods and systems of the present invention, image defects stemming from variance or drift of the threshold values due to aging of the printhead and the like are reduced or eliminated.

Image defects stemming from long-term and short-term temporal drift of print threshold values are perceptible to the human eye, and thus are unacceptable for a photo-quality print. That is, if the ink droplets are ejected to a recording medium without adjusting for these defects, the final printed image will include the defects. These defects, even if only a few mils or tens of microns, are well within the visual acuity of the human eye. Since the human eye can sense these defects, the quality of the resulting image suffers greatly even for small defects.

In various exemplary embodiments of the methods and systems of this invention, print conditions are determined through periodic quality adjustment cycles based on detected long-term and short-term temporal drift of print thresholds.

In various exemplary embodiments of the methods and systems of this invention, in an adjustment cycle, print conditions for controlling ink ejection are determined based on the variance in threshold values.

In various exemplary embodiments of the methods and systems of this invention, a detector is provided to detect the presence or absence of ink being ejected from an inkjet printer.

In one exemplary embodiment of the methods and systems of this invention, a sequence of eject and detect cycles over varying control conditions is performed to determine the minimum condition required to eject ink from the printer.

In various exemplary embodiments of the methods and systems of this invention, print quality is maintained by determining print conditions based on varying threshold values over printhead lifetime during preimaging.

These and other features and advantages of this invention are described in or are apparent from the following detailed description of the exemplary embodiments.

### BRIEF DESCRIPTION OF THE DRAWINGS

Various exemplary embodiments of this invention will be described in detail, with reference to the following figures, wherein:

FIG. 1 shows one exemplary embodiment of an image processing apparatus that incorporates print condition determination control according to this invention;

FIG. 2 shows one exemplary embodiment of a printing apparatus that incorporates the print condition determination control of this invention;

FIG. 3 shows in greater detail, one exemplary embodiment of the printing apparatus provided with the print condition determination control shown in FIG. 2;

FIG. 4 is a flowchart outlining one exemplary embodiment of an image processing method according to this invention; and

FIG. 5 is a flowchart outlining one exemplary embodiment of an print condition determination control method according to this invention.

### DETAILED DESCRIPTION OF PREFERRED EMBODIMENTS

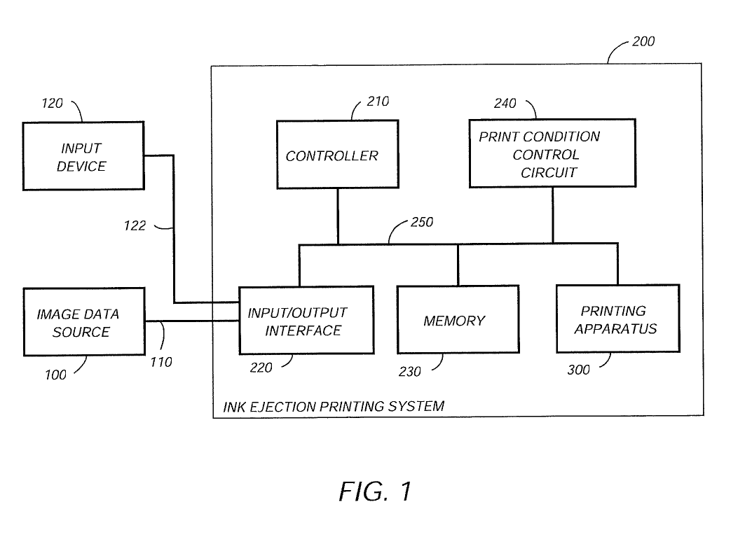

FIG. 1 shows one exemplary embodiment of an ink ejection printing system 200 incorporating print condition determination control in accordance with this invention. As shown in FIG. 1, an image data source 100 and an input device 120 are connected to the ink ejection printing system 200 over links 110 and 122, respectively. The image data source 100 can be a digital camera, a scanner, or a locally or remotely located computer, or any other known or later developed device that is capable of generating or otherwise providing electronic image data. Similarly, the image data source 100 can be any suitable device that stores and/or transmits electronic image data, such as a client or a server of a network. The image data source 100 can be integrated with the ink ejection printing system 200, or the image data source 100 can be connected to the ink ejection printing system 200 over a connection device, such as a modem, a local area network, a wide area network, an intranet, the Internet, any other distributed processing network, or any other known or later developed connection device.

It should also be appreciated that, while the electronic image data can be generated at the time of printing an image from electronic image data, the electronic image data could have been generated at any time in the past. Moreover, the electronic image data need not have been generated from an original physical document, but could have been created from scratch electronically. The image data source 100 is thus any known or later developed device which is capable of supplying electronic image data over the link 110 to the ink ejection printing system 200. The link 110 can thus be any known or later developed system or device for transmitting the electronic image data from the image data source 100 to the ink ejection printing system 200, such as an electrical cable, an optical cable, infrared light transmission, or other electromagnetic wavelength transmission methods.

The input device 120 can be any known or later developed device for providing control information from a user to the ink ejection printing system 200. Thus, the input device 120 can be a control panel of the ink ejection printing system 200, or could be a control program executing on a locally or remotely located general purpose computer, or the like. As with the link 110 described above, the link 122 can be any known or later developed device for transmitting control signals and data input using the input device 120 from the input device 120 to the ink ejection printing system 200.

As shown in FIG. 1, the ink ejection printing system 200 includes a controller 210, an input/output interface 220, a memory 230, an print condition determination control circuit 240 and a printing apparatus 300, each of which is interconnected by a control and/or data bus 250. It should be appreciated that any or all of these elements can be combined into one or more microelectronic integrated circuits including a microprocessor or microcontroller. The links 110 and 122 from the image data source 100 and the input device 120, respectively, are connected to the input/output interface 220. The electronic image data from the image data source 100, and any control and/or data signals from the input device 120, are input through the input interface 220, and, under control of the controller 210, are stored in the memory 230 and/or provided to the controller 210.

The memory 230 preferably has at least an alterable portion and may include a fixed portion. The alterable portion of the memory 230 can be implemented using static or dynamic RAM, a floppy disk and disk drive, a hard disk and disk drive, flash memory, or any other known or later developed alterable volatile or non-volatile memory device. If the memory includes a fixed portion, the fixed portion can be implemented using a ROM, a PROM, an EPROM, and EEPROM, a CD-ROM and disk drive, a DVD-ROM and disk drive, a writable optical disk and disk drive, or any other known or later developed fixed memory device.

The ink ejection printing system 200 shown in FIG. 1 is connected to the printing apparatus 300 over the control and/or data bus 250. Alternatively, the printing apparatus 300 may be an integral part of the ink ejection printing system 200. An example of this alternative configuration would be a digital copier or the like. It should be appreciated that the ink ejection printing system 200 can be any known or later developed type of image processing apparatus. There is no restriction on the form the ink ejection printing system 200 can take.

The links 110 and 122 can be any known or later developed device or system for connection, including a direct cable connection, a connection over a wide area network or a local area network, a connection over an intranet, a connection over the Internet, or a connection over any other distributed processing network or system. In general, the links 110 and 122 can be any known or later developed connection system or structure usable for connection.

During preimaging, in a plurality of adjustment cycles, the print condition determination circuit 240 determines the variance in the thresholds detected by a print condition detector, and based on the determined variance, determines the print condition values to be stored in the memory 230 for each print element.

During imaging, the print condition determination circuit 240 inputs signals from the image data source 100. The print condition determination circuit 240 selects the print condition values stored in the memory 230 for each print element based on the input signals. The print condition determination circuit 240 outputs the selected print condition values to the printing apparatus 300 over the control and/or data bus 250. That is, based on the determination made by the print condition determination circuit 240 and the image data, the print condition determination circuit 240 controls the print condition of the print elements in the printing apparatus 300. These print conditions have been determined based on the determined variance to reduce or eliminate defects due to device aging and the like during the adjustment cycles. Accordingly, when the output images are output to the printing apparatus 300, the resulting image will be output on a receiving substrate or display with reduced or eliminated image defects.

While FIG. 1 shows the print condition determination control circuit 240 and the printing apparatus 300 as portions of an integrated system, the print condition determination control circuit 240 could be provided as a separate device from the printing apparatus 300. That is, the print condition determination control circuit 240 may be a separate device attachable upstream of a stand-alone printing apparatus 300. For example, the print condition determination control circuit 240 may be a separate device which interfaces with both the image data source 100 and the printing apparatus 300.

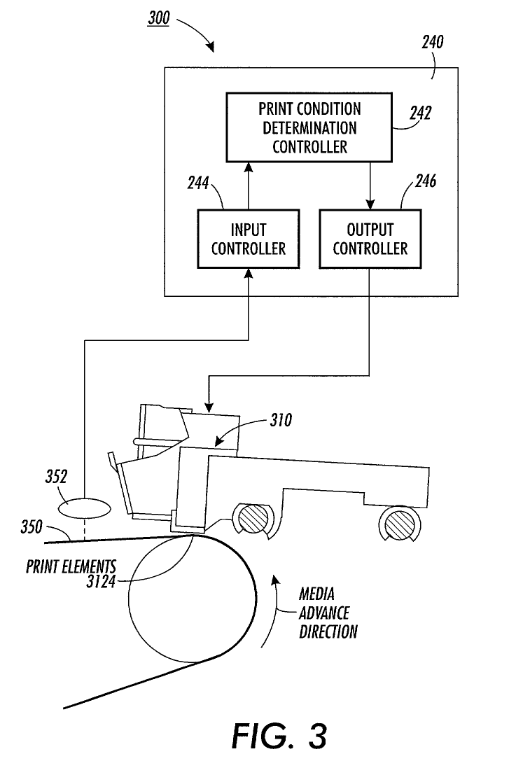

For example, the print condition determination control circuit 240 and the print condition detector 352, as shown in FIG. 3, may be implemented as devices which interface with both the image data source 100 and the printing apparatus 300. For example, the print condition determination control circuit 240 may be incorporated into a network print server that forms a portion of the image data source 100 and that receives the sensor signals from the condition detector 352, and controls the output of the image data by the printing apparatus 300.

Furthermore, the print condition determination control circuit 240 may be implemented as software on the ink ejection printing system 200 or the image data source 100. Other configurations of the elements shown in FIG. 1 may be used without departing from the spirit and scope of this invention.

It should be appreciated that, according to the systems and methods of this invention, each print element is controlled to form the image based on the print condition determination, so that, when the image is formed on, or transferred to, the receiving medium, image defects for that image on the receiving medium are reduced, if not eliminated.

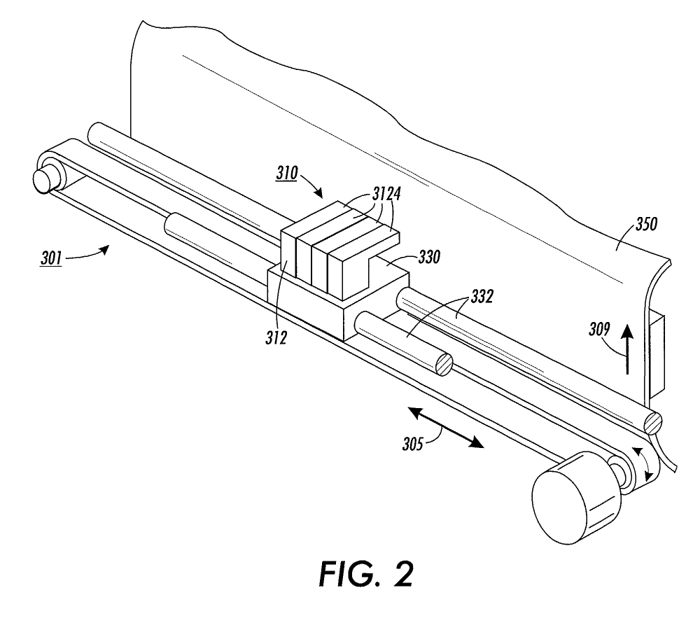

FIG. 2 shows one exemplary embodiment of a portion of the printing apparatus 300 usable with the print condition determination control systems and methods according to this invention. As shown in FIG. 2, the printing apparatus 300 includes an ink cartridge 310 mounted on a carriage 330 supported by carriage rails 332. The carriage rails 332 extend along the media motion or fast scan direction. The carriage 330 moves along the carriage rails 332.

The cartridge 310 includes a housing 312 containing fluid, such as, for example, ink. The cartridge 310 selectively expels droplets of fluid under control of electrical signals received from print condition determination control circuit 240 through a signal cable or other transmission medium. It should be appreciated that the housing 312 can contain any fluid in which the expulsion of the droplets can be controlled. The fluid can include, but is not limited to including, various toners, waxes, conditioning fluids or overcoating fluids.

The cartridge 310 contains a plurality of channels that carry the fluid from the housing 312 to a respective plurality of print elements 3124 displaced relative to each other in the fast scan direction. This allows printing a plurality of rows of fluid drops. The separation between each of the print elements 3124 in the fast scan direction combined with the relative timing of the drop ejections between the moving carriage 330 and the receiving substrate or medium 350 corresponds to the drop pitch for a desired resolution.

When printing the fluid onto a receiving substrate or medium 350, the carriage 330 reciprocates or scans back and forth along the carriage rails 332 in the directions of the arrow 305. As The cartridge 310 reciprocates back and forth across the recording medium 350, such as a sheet of paper or transparency, droplets of fluid are expelled from selected nozzles of selected ones of the print elements 3124 towards the recording medium 350. The print elements 3124 are typically arranged in a linear array perpendicular to the scanning direction 305 but also can be arranged in any substantially non-parallel position relative to the scanning direction 305. During each pass of the carriage 330, the recording medium 350 is held in a stationary position. At the end of each pass, however, the recording medium 350 is stepped by a stepping or servo-controlled mechanism under control of the printer controller 210 in the direction of an arrow 309.

It should be appreciated that, although FIG. 2 shows the printing apparatus 300 as a carriage-type printer, any other printing or image forming apparatus which includes a plurality of or a hybrid assembly of print elements, such as a page width printer, may use the print condition determination control systems and methods according to this invention. A page width printer includes a stationary cartridge or print array having a length sufficient to print across the width or length of a recording medium at a time. The page width cartridge includes a large number of print elements. The recording medium is continually moved or stepped past the page width cartridge in a direction substantially normal to the cartridge length and at a constant or varying speed or stepper rate during the printing process.

It should also be appreciated that, although FIG. 2 shows that the cartridge 310 has four print elements, the cartridge can contain any number of print elements. The print elements in the cartridge can include, but are not limited to including, various colors of ink, or various tones of one or more of the colors, various spot sizes, or any other fluids.

Furthermore, it should also be appreciated that, although FIG. 2 shows that each of the cartridge 310 contains print elements as active arrays and are incorporated into a printing apparatus, each cartridge can be any active array structure usable to form an image formed of discretely created pixels, and the apparatus 300 can be any device that uses such active arrays. The active arrays in the multi-element active array structure can thus also include, but are not limited to, light emitting elements and light sensitive elements. An example of the multi-element active array structure including light emitting elements and light sensitive elements is described in U.S. Pat. No. 5,192,959 to Drake et al. incorporated herein by reference in its entirety. Other types of apparatus which can use multi-element active arrays and thus are usable with the ink ejection printing system 200 according to this invention include but are not limited to, thermal image forming devices, piezo-electric ink jet devices and page-width print bar type xerographic (i.e., laser) image forming devices.

FIG. 3 shows in greater detail one exemplary embodiment of the printing apparatus 300 shown in FIG. 2 and the print condition determination control circuit 240 shown in FIG. 1.

As shown in FIG. 3, the print condition determination circuit 240 includes an input controller 244, the output controller 246, and a print condition determination controller 242. The output controller 246 controls the output signals to the ink cartridge 310.

The input controller 244 inputs signals from the image data source 100. The print condition determination controller 242 selects the print condition determination values stored in the memory 230 for each print element or group of print elements based on the input signals. The output controller 246 then outputs the selected print condition determination values to the printing apparatus 300 over the control and/or data bus 250. The output controller 246 thus controllably outputs the control signals to the print elements 3124 to control the firing of the ink droplets from the print elements 3124.

The printing apparatus 300 includes a print condition detector 352 which detects drift in threshold values of the printing condition of the cartridges in the printing apparatus 300, and inputs the detection results over the control and/or data bus 250 to the print condition determination control circuit 240. It should be appreciated that the print condition detector 352 could be integrated in any or each of the print elements 3124 as well. The print condition determination circuit 240 determines the print conditions according to variance in the thresholds detected by the print condition detector 352 and stores the print conditions in the memory 230. During the print run, the print condition determination circuit 240 selects the print condition values stored in the memory 230 for each print element based on the input signals.

Based on the print condition determination determined by the print condition determination control circuit 240, the print condition determination control circuit 240 controls the output of the image data, and/or a motor which controls the movement of the cartridge. Accordingly, when the image is printed, it would not contain the defects from the varying threshold values.

The print condition values for the individual print elements 3124 within the cartridge 310 may be stored and associated with or incorporated into the cartridge during set-up. The print condition determination control circuit 240 controls when ink droplets are ejected from the print elements 3124 by selecting the determined print condition value stored in the memory 230 for each print element based on the input signals from the image data source 100 to produce the final image.

During preimaging, the print condition determination control circuit 240 determines variance in the threshold values for print conditions of each individual print element with values determined from the print condition detector 352. These thresholds are stored, for example, in the memory 230.

At machine start-up, when recovering from unknown conditions, or in low-power standby modes, for example, a plurality of adjustment cycles are performed. These are the preferred times that the control set-up procedure is performed, but could be performed at other junctures as well. During these adjustment cycles, the print conditions are determined based on the variance in thresholds and stored in the memory 230 in a nominal table, for example. The nominal table serves to link the print element print condition determination values for each individual print element 3124 of a given cartridge. These print conditions include, but are not limited to, the pulse width, gate electrode and bum voltage, current, or power of the input signals to the print elements 3124. It should be appreciated that the print conditions are not limited as described above, and that the firing of the print elements can thus controlled using any known or later developed method.

The print condition determination control circuit 240 will select the print condition values for the print elements 3124 from the nominal table based on the input signals from the image data source 100. The print condition determination control circuit 240 then outputs image control signals that control how the print elements are fired to the printing apparatus 300.

It should be appreciated that though the print condition detector 352 of FIG. 3 is shown to be an element included in the cartridge 310, the print condition detector 352 can be any known or later developed mechanism, device or structure used to sense the condition of the print element. That is, the print condition detector 352 may be a separate device attachable to the cartridge 310 or positioned in print condition determination control circuit 240 separate from the cartridge 310. For example, the print condition detector 352 may be a hardware in a maintenance station which interfaces with the print condition determination control circuit 240 and cartridge 310. The print condition detector 352 may also be an integrated microelectronic sensing element, structure, sub-circuit, or combination thereof included during the fabrication of the print element.

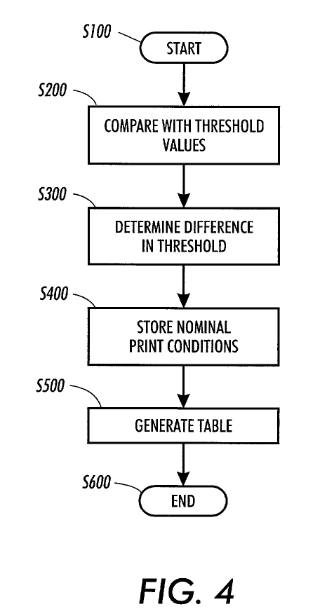

FIG. 4 is a flowchart outlining one exemplary embodiment of the set-up method of this invention. Starting in step S100, control continues to step S200, where the stored threshold values are compared with detected print condition values through a process of data collection from a print condition detector 352. Then, in step S300, the difference in the two values is determined to obviate any differences in threshold values. Control then continues to step S400.

In step S400, the print conditions determined based on the variance in threshold values during the set-up procedure are stored as the nominal print conditions. Next, in step S500, the nominal print condition table is generated. The nominal print condition table serves to link the set-up determination of threshold variance and the image signals. Then in step S600, the control routine ends.

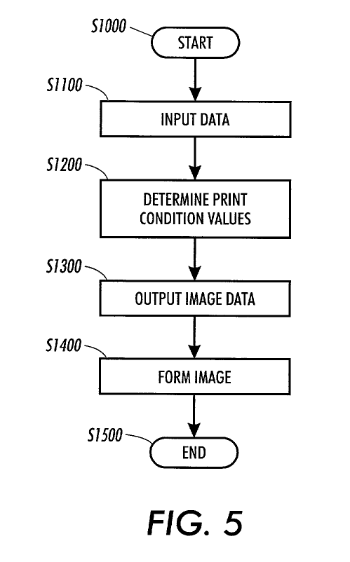

FIG. 5 is a flowchart outlining one exemplary embodiment of the printing method based on the determined print condition of this invention. Beginning at step S1000, control continues to step S1100, where the electronic image data is input. Next, in step S1200, the print condition values stored during set-up are determined based on the input image data. Control then continues to step S1300.

In step S1300, the image data is output based on the print condition values. Next, in step S1400, the output image is formed by the printer using the determined image data. Control then continues to step S1500, where the control routine ends.

The ink ejection printing system 200 shown in FIG. 1 is preferably implemented on a programmed general purpose computer. However, the ink ejection printing system 200 shown in FIG. 1 can also be implemented on a special purpose computer, a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA or PAL, or the like. In general, any device, capable of implementing a finite state machine that is in turn capable of implementing the flowcharts shown in FIGS. 4 and 5, can be used to implement the ink ejection printing system 200.

In particular, it should be understood that each of the circuits shown in FIG. 1 can be implemented as portions of a suitably programmed general purpose computer. Alternatively, each of the circuits shown in FIG. 1 can be implemented as physically distinct hardware circuits within an ASIC, or using a FPGA, a PDL, a PLA or a PAL, or using discrete logic elements or discrete circuit elements. The particular form each of the circuits shown in FIG. 1 will take is a design choice and will be obvious and predicable to those skilled in the art.

The memory 230 is preferably implemented using static or dynamic RAM. However, the memory 230 can also be implemented using a floppy disk and disk drive, a writable optical disk and disk drive, a hard drive, flash memory, magnetic storage medium, or any other known or later developed alterable volatile or non-volatile memory device or system.

While this invention has been described in conjunction with the exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

What is claimed is:

1. A method for printing an image, comprising:
inputting image data representing an image;
determining stored print condition values based on the input image data; and
outputting the image data based on the determined stored print condition values.

2. The image processing method of claim 1, further comprising performing a set-up procedure that includes storing print condition values.

3. The image processing method of claim 2, the print condition values being determined through periodic quality adjustment cycles.

4. The image processing method of claim 3, further comprising determining long-term and short-term temporal drift of print thresholds, wherein the print condition values are determined based on the determined long-term and short-term temporal drift of print thresholds.

5. The image processing method of claim 3, further comprising determining variance in print thresholds, wherein the print condition values are determined based on the determined variance in print thresholds.

6. The image processing method of claim 1, further comprising determining presence or absence of ink being ejected.

7. The image processing method of claim 6, further comprising performing a sequence of eject and detect cycles over varying control conditions.

8. The image processing method of claim 7, further comprising determining minimum condition required to eject ink in the sequence of eject and detect cycles.

9. The image processing method of claim 1, the determined print condition values being determined based on varying threshold values during preimaging.

10. The image processing method of claim 9, the determined print condition values being determined over lifetime of a printhead.

11. An apparatus for printing an image, comprising:
an image input device that inputs image data representing an image;
a print condition determination circuit that determines stored print condition values based on the input image data; and
an image output device that outputs the image data based on the determined stored print condition values.

12. The apparatus of claim 11, further comprising a memory for storing print condition values, wherein the print condition determination circuit performs a set-up procedure that includes storing the print condition values in the memory.

13. The apparatus of claim 12, the print condition values being determined through periodic quality adjustment cycles.

14. The apparatus of claim 13, further comprising a detector that detects long-term and short-term temporal drift of print thresholds, wherein the print condition values are determined based on the detected long-term and short-term temporal drift of print thresholds.

15. The apparatus of claim 13, further comprising a detector that detects variance in print thresholds, wherein the print condition values are determined based on the determined variance in print thresholds.

16. The apparatus of claim 11, further comprising a detector that detects presence or absence of ink being ejected.

17. The apparatus of claim 16, the print condition determination circuit performing a sequence of eject and detect cycles over varying control conditions.

18. The apparatus of claim 17, the print condition determination circuit determining minimum condition required to eject ink in the sequence of eject and detect cycles.

19. The apparatus of claim 11, the determined print condition values being determined based on varying threshold values during preimaging.

20. The apparatus of claim 19, further comprising a printhead, the determined print condition values being determined over lifetime of the printhead.
